(19) United States
(12) Patent Application Publication
(10) Pub. No.: US 2023/0126985 A1
(43) Pub. Date: Apr. 27, 2023

(54) FULLY SOLID BATTERY AND MODULE OF THE SAME

(71) Applicant: SAMSUNG SDI CO., LTD., Yongin-si (KR)

(72) Inventors: Minsuk LEE, Yongin-si (KR); Suyeol RYU, Yongin-si (KR); Isaac SHIN, Yongin-si (KR); Jihyoung PARK, Yongin-si (KR); Young Gyoon RYU, Yongin-si (KR); Jaegu YOON, Yongin-si (KR)

(21) Appl. No.: 17/968,070

(22) Filed: Oct. 18, 2022

(30) Foreign Application Priority Data
Oct. 25, 2021 (KR) 10-2021-0142958

(51) Int. Cl. H01M 10/0585; H01M 4/66; H01M 50/211; H01M 50/209; H01M 50/289; H01M 50/264

(52) U.S. Cl. CPC H01M 10/0585; H01M 4/667; H01M 50/211; H01M 50/209; H01M 50/289; H01M 50/264

(57) ABSTRACT

A fully solid battery includes a positive electrode plate, a solid electrolyte layer disposed on one side of the positive electrode plate, a negative electrode plate disposed on one side of the solid electrolyte layer, and a buffer film disposed on one side of the negative electrode plate. The buffer film includes a base substrate and a buffer layer on at least one surface of the base substrate. The buffer layer includes a first particulate that provides resilience, a second particulate that relieves stress, and a binder.

### CROSS-REFERENCE TO RELATED APPLICATION

This application claims priority to and the benefit of Korean Patent Application No. 10-2021-0142958 filed in the Korean Intellectual Property Office on Oct. 25, 2021, the entire contents of which are incorporated herein by reference.

### BACKGROUND

### 1. Field

Embodiments relate to a fully solid battery and a battery module including the same.

### 2. Description of the Related Art

A fully solid battery may include a positive electrode plate, a solid electrolyte layer, and a negative electrode plate. The solid electrolyte layer may be a medium that conducts lithium ions. In a case of a lithium precipitation fully solid battery (or a lithium metal battery), lithium ions are deposited to a metal on the negative electrode plate to accumulate lithium, i.e., lithium metal is deposited on the negative electrode plate, during charging. That is, during charging, the lithium ions transferred from the positive electrode plate are deposited on the negative electrode plate. Also, during discharging, the lithium ions from the negative electrode plate are dissociated and transferred to the positive electrode plate.

The fully solid battery with the precipitation-type negative electrode plate may be formed without a housing. Also, such a battery may or may not include an active material in the negative electrode plate.

The above information disclosed in this Background section is only for enhancement of understanding of the background of the invention, and therefore it may contain information that does not form the prior art that is already known in this country to a person of ordinary skill in the art.

### SUMMARY

A fully solid battery according to an embodiment includes: a positive electrode plate; a solid electrolyte layer disposed on one side of the positive electrode plate; a negative electrode plate disposed on one side of the solid electrolyte layer; and a buffer film disposed on one side of the negative electrode plate, wherein the buffer film includes a base substrate, and a buffer layer formed by attaching a first particulate formed on at least one surface of the base substrate to provide resilience and a second particulate that relieves stress by a binder.

The buffer layer may form a closest packing structure in which the first particulate and the second particulate are in contact with each other.

The first particulate and the second particulate have a particle diameter that is equal to or smaller than a particle diameter of the positive active material formed on the positive electrode plate.

The first particulate may consist of at least one of polystyrene powder and silicone powder, and the second particulate may be composed of at least one of an acryl powder and a polytetrafluoroethylene powder.

The positive electrode plate, the solid electrolyte layer, and the negative electrode plate may form a unit cell that acts for charging and discharging on one side of the positive electrode plate as a mono-cell.

The positive electrode plate, the solid electrolyte layer, and the negative electrode plate may form a unit cell that acts for charging and discharging on both sides of the positive electrode plate as a bi-cell.

A fully solid battery module according to an embodiment includes: a plurality of stacked cells formed by stacking at least one unit cell including: a positive electrode plate; a solid electrolyte layer disposed on one side of the positive electrode plate; a negative electrode plate disposed on one side of the solid electrolyte layer, and a buffer film disposed on one side of the negative electrode plate, upper and lower plates provided on the top and bottom surfaces of all stacked cells, a buffer pad disposed between a plurality of stacked cells, between the uppermost surface and the upper plate and between the lowermost and the lower plate, and a fastening member fastening the upper plate and the lower plate.

The stacked cells may be formed as a pouch type or a can type.

A fully solid battery module according to an embodiment includes a plurality of stacked cells formed by stacking at least one unit cell including: a positive electrode plate; a solid electrolyte layer disposed on one side of the positive electrode plate; a negative electrode plate disposed on one side of the solid electrolyte layer; and a buffer film disposed on one side of the negative electrode plate, and a buffer pad disposed between a plurality of unit cells, wherein the buffer pad is formed in one sheet and is interposed in a continuous structure of a Z-stack type between the unit cells.

The unit cell may be formed as a bi-cell.

### BRIEF DESCRIPTION OF THE DRAWINGS

Features will become apparent to those of skill in the art by describing in detail example embodiments with reference to the attached drawings in which:

FIG. 1 is a cross-sectional view of a charge state of a fully solid battery according to a first example embodiment.

FIG. 2 is a cross-sectional view of a charge state of a fully solid battery according to a second example embodiment.

FIG. 3 is a top plan view of a positive electrode plate, a negative electrode plate, and a finishing member applied in FIG. 1 and FIG. 2.

FIG. 4 is an enlarged cross-sectional view of a buffer film applied to FIG. 1 and FIG. 2.

FIG. 5 is a cross-sectional view of a fully solid battery module according to a third example embodiment.

FIG. 6 is a cross-sectional view of a fully solid battery module according to a fourth example embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey example implementations to those skilled in the art. In the drawing figures, the dimensions of layers and regions may be exaggerated for clarity of illustration. Like reference numerals refer to like elements throughout.

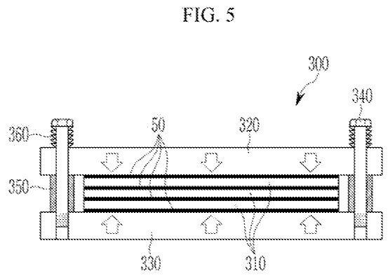

An all-solid-state battery containing a sulfide-based solid electrolyte may be pressed at high pressure. In general, as lithium is deposited on a negative electrode plate during charging, a volume of the fully solid battery may tend to increase (e.g., the battery may try to expand). Also, the lithium precipitation may tend to be non-uniform, e.g., in a free state in which pressure is not applied to the fully solid battery. In the case of non-uniform lithium precipitation, as the charging and discharging proceeds, the non-uniformity of the lithium precipitation may be amplified and the solid electrolyte layer may be partially broken by uneven internal forces. Such a breakage may cause, e.g., an internal short circuit. The non-uniformity of the lithium precipitation may be addressed at least in part by applying pressure to the outside of the fully solid battery, e.g., by an upper plate 320 and a lower plate 330 compressed by a spring 360 and a fastening member 340, as shown in an example embodiment in FIG. 5, described below.

Additionally, lithium that is deposited on a negative electrode plate of a fully solid battery may be pure lithium and that may easily react with residual impurities that may vaporize inside the fully solid battery to be oxidized to lithium oxide. Lithium that is oxidized by the reaction with impurities cannot be used during discharge, and thus the capacity of the fully solid battery may be deteriorated. In general, it may be difficult to ensure that no such impurities remain inside the fully solid battery, such that the formation of lithium oxide may be difficult to entirely prevent. In addition, a sulfide solid electrolyte may break easily after pressing. In this regard, lithium oxide has a high elastic modulus and the amount thereof may be locally increased, such that a localized stress is applied to the solid electrolyte layer. This may cause partial breakage of the solid electrolyte layer and an internal short circuit.

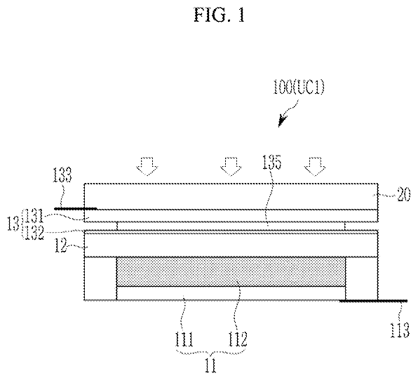

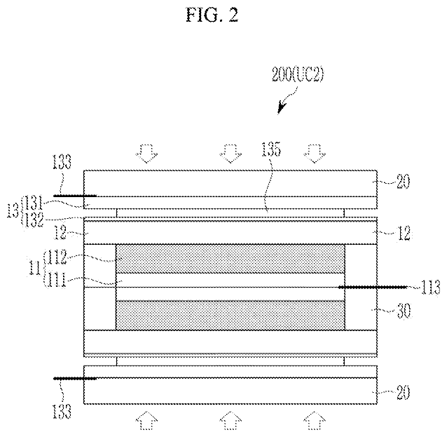

FIG. 1 is a cross-sectional view of a charge state of a fully solid battery according to a first example embodiment. FIG. 2 is a cross-sectional view of a charge state of a fully solid battery according to a second example embodiment.

Referring to FIG. 1, a fully solid battery 100 according to the first example embodiment may include a positive electrode plate 11 having a positive current collector 111 and a positive active material layer 112, and a negative electrode plate 13 having a negative current collector 131 and a negative active material layer 132. Referring to FIG. 2, a fully solid battery 200 according to the second example embodiment may be formed as a unit cell UC2 that is a bi-cell that charges and discharges from both sides, e.g., upper and lower sides in FIG. 2. In the bi-cell, the positive electrode plate 11 may include positive active material layers 112 on both sides of the positive current collector 111, and a pair of the negative electrode plates 13 may be disposed with the positive electrode plate 11 therebetween. In FIGS. 1 and 2, arrows pointing downward toward the unit cell and upward toward the unit cell indicate externally applied pressure, which may be provided by a structure the same as or similar to the upper plate 320, the lower plate 330, the spring 360, and the fastening member 340 shown in the example embodiment in FIG. 5, described below.

A solid electrolyte layer 12 may be disposed on one side of the positive electrode plate 11, e.g., between the positive electrode plate 11 and the negative electrode plate 13, and a buffer film 20 may be disposed on one side of the negative electrode plate 13, e.g., on an opposite side from where the solid electrolyte layer 12 is. Further details regarding the compositions and functions of the buffer film are set forth below.

Referring to FIGS. 1 and 2, a lithium precipitated layer 135 may be present, e.g., depending on a state of charge.

The positive electrode plate 11 may include an uncoated region 113 that is protruded on one side, and the negative electrode plate 13 may include an uncoated region 133 protruded to one side.

In FIG. 1, the positive electrode plate 11, the solid electrolyte layer 12, and the negative electrode plate 13 may be arranged as a stacked structure that forms a unit cell UC1, which may be a mono-cell that charges and discharges from one side of the positive electrode plate 11. On the other hand, in FIG. 2, the fully solid battery 200 according to the second example embodiment may be formed as the unit cell UC2, which may be a bi-cell that charges and discharges from both sides, e.g., two opposite sides, of the positive electrode plate 11.

In the bi-cell, the positive electrode plate 11 may include positive active material layers 112 on both sides of the positive current collector 111, which may be made of aluminum.

In an implementation, a carbon layer (not shown), e.g., a carbon layer having a high binder content of a 1-3 μm thickness, may be coated on both sides of the positive current collector 111, and the positive active material layer 112 may be coated on the carbon layer.

Referring to FIG. 1 and FIG. 2, the lithium precipitated layer 135 may not be present in a discharged state. The lithium precipitated layer 135 may be formed by moving lithium ions from the positive electrode plate 11 and being precipitated on one surface of the negative current collector 131, in a charged state. During discharge, lithium ions in the lithium precipitated layer 135 may be dissociated and transferred to the positive electrode plate 11, so that the lithium precipitated layer 135 is removed.

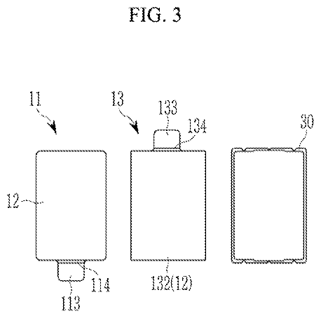

FIG. 3 is a top plan view of a positive electrode plate, a negative electrode plate, and a finishing member applied in FIG. 1 and FIG. 2.

Referring to FIG. 2 and FIG. 3, the positive electrode plate 11 includes the uncoated region 113 protruded on one side. The positive active material layer 112 may be formed to be protruded in the uncoated region 113 side and to protrude to 0.7 mm or less in that direction.

The positive active material layer 112 formed in the uncoated region 113 may have taping 114 (e.g., with a thickness of 10-30 μm and a width of 2 mm) at the boundary of the uncoated region 113. The providing of the taping 114 of the positive active material layer 112 surface may help to prevent the positive active material from falling off and short-circuiting.

The negative electrode plate 13 may include the negative active material layer 132 on one surface of the negative current collector 131 formed of stainless steel (SUS) or nickel-coated copper (Ni-coated Cu).

For convenience, the negative active material layer 132 is shown, but the negative active material layer 132 may not be present. In this case, the precipitated lithium precipitated layer 135 may act as a negative active material layer.

Also, only a polymer layer, such as a polyvinylidene fluoride layer, may be formed on one surface of the negative current collector 131.

The solid electrolyte layer (SE) 12 may be laminated on the negative active material layer 132. In an implementation, this lamination method may be preformed by direct coating of a solid electrolyte slurry, transferring of a solid electrolyte film, or lamination bonding between a solid electrolyte film of a free-standing negative electrode active material layer 12.

A free-standing solid electrolyte film may include a non-woven fabric with a thickness of 15 μm inside.

The negative electrode plate 13 may have the uncoated region 133 protruded to one side. The negative active material layer 132 may be formed to be protruded toward the uncoated region 133, e.g., to protrude to 0.7 mm or less in that direction. The negative active material layer 132 formed in the uncoated region 133 may have taping 134 with a thickness of, e.g., 10-30 μm, and a width of, e.g., 2 mm, at a boundary of the uncoated region 133. The treatment of the taping 134 of the negative active material layer 132 surface may help to prevent the negative electrode active material from falling off and short-circuiting.

The fully solid battery 200 may include a finishing member 30. The finishing member 30 may be formed of, e.g., a composite of a nonflammable metal oxide and pulp, and may be configured to allow the uncoated region 113 to extend while surrounding the positive electrode plate 11.

The finishing member 30 may include, e.g., a pulp fiber, a glass fiber, Al(OH)₃, and a binder. The glass fiber may help to increase the strength of the pulp fiber. The Al(OH)₃ may act as an H₂O adsorbent (i.e., a getter) below 100° C. and provide nonflammablility for the composite material at 150° C. or higher. The binder may provide bonding strength for the other components.

The finishing member 30 may provide a uniform pressurization to the solid electrolyte layer 12 in a heating plate press of the stacked fully solid batteries 100 and 200, may provide uniform pressurization even during cell evaluation, may prevent residual moisture (H₂O) from flowing in during a cell manufacturing process of an aluminum pouch, may block residual moisture that may be generated during the charging and discharging, and may release moisture (H₂O) at a high temperature of 150° C. or higher so as to prevent the temperature from becoming higher.

The buffer film 20 may be disposed on a rear surface of the negative current collector 131 of the negative electrode plate 13 (e.g., on an opposite side from the solid electrolyte layer 12), and may be configured to provide an elastic force to the negative active material layer 132 and the negative current collector 131 (e.g., to provide elasticity between externally applied pressure and pressure that develops within the fully solid battery) in response to the formation/dissociation of the lithium precipitated layer 135 from lithium precipitation and dissociation during charging and discharging.

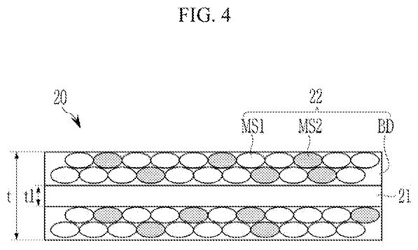

FIG. 4 is an enlarged cross-sectional view of a buffer film applied to FIG. 1 and FIG. 2.

Referring to FIG. 4, the buffer film 20 may include a base substrate 21 and a buffer layer 22. The buffer film 20 may have the buffer layer 22 on both sides or one surface of the base substrate 21. The buffer layers 22 may each include a first particulate MS1, a second particulate MS2, and a binder BD.

The buffer film 20 may be configured to have breathability. If the buffer film 20 were to be in a solid, e.g., rigid or impermeable, form, an air layer may be formed between the rear surface of the negative electrode plate 13 and the buffer film 20, and this air layer may cause local non-uniform pressurization.

The base substrate 21 may be formed of a PE (polyethylene) fabric or a PP (polypropylene) fabric. The base substrate 21 may be formed of a material that is generally used for a separator of a lithium ion battery (LIB), or a porous polymer film. The base substrate 21 may have a characteristic of independent point elasticity (viscoelasticity). The base substrate 21 may be supplied in a reel method and be applied to a Z-stack process (described further below).

The buffer layer 22 may be formed by attaching a plurality of particulates (microspheres, MS1 and MS2 having respectively different mechanical properties) in the binder (BD) having high adhesion, to the base substrate 21 with a constant ratio. The buffer layer 22 may be formed of a particulate coating on the base substrate 21 to provide a buffering effect.

The buffer layer 22 may be formed by attaching the first particulate MS1 that provides a restoring force, and the second particulate MS2 that relieves stress, in the binder BD, on at least one surface of the base substrate 21. The buffer layer 22 may be in the form of a closest packing structure, in which the first particulate MS1 and the second particulate MS2 are in contact with each other.

The first particulate MS1 is an elasticity material with high resilience.

The second particulate MS2 is a damping material with high stress relief.

The binder BD is a material that increases an adhesion force between the first and second particulates MS1 and MS2, and between the first and second particulates MS1 and MS2 and the base substrate 21.

The entire thickness t of the buffer film 20 may be 15-50 μm, e.g., 25-30 μm under pressure (arrows in FIGS. 1 and 2), and at the same time the thickness t1 of the base substrate 21 may be 1-10 μm, e.g., 3-5 μm.

The first particulate MS1 and the second particulate MS2 may have a particle diameter, e.g., an average particle diameter, that is equal to or smaller than that of the positive active material forming the positive active material layer 112 on the positive electrode plate 11.

The first particulate MS1 may be formed of or consists of at least one type of polystyrene powder and silicone powder. The first particulate MS1 may be made of polyurethane or silicone rubber that provides resilience.

The second particulate MS2 may be formed of or consist of at least one of an acryl powder and polytetrafluoroethylene (PTFE) powder.

TABLE 1

| | Buffer film | | | | | | | |
|---|---|---|---|---|---|---|---|---|
| | Material, wt ratio, thickness | | | | Evaluation | | | |
| | | | Thick- | | | | Product- | Shorting |
| | Base | | ness | Supply | Stack | Energy | ion | occurrence |
| | substrate | MS1:MS2 | (μm) | method | process | density | speed | time |
| Ex. 1 | PE | 1.0:0.0 | 50 | Reel | ◯ | Good | 8 | >150 |
| Ex. 2 | PE | 0.7:0.3 | 50 | Reel | ◯ | Good | 8 | >215 |
| Ex. 3 | PE | 0.5:0.5 | 50 | Reel | ◯ | Good | 8 | >270 |
| Ex. 4 | PE | 0.3:0.7 | 50 | Reel | ◯ | Good | 8 | >330 |
| Ex. 5 | PE | 0.0:1.0 | 50 | Reel | ◯ | Good | 8 | >300 |
| Ex. 6 | PP | 0.3:0.7 | 100 | Reel | ◯ | Fair/poor | 8 | >450 |
| Ex. 7 | PP | 0.3:0.7 | 70 | Reel | ◯ | Fair | 8 | >400 |
| Ex. 8 | PP | 0.3:0.7 | 50 | Reel | ◯ | Good | 8 | >350 |
| Ex. 9 | PP | 0.3:0.7 | 30 | Reel | ◯ | Excellent | 8 | >200 |
| Ex. 10 | PP | 0.3:0.7 | 10 | Reel | ◯ | Excellent | 8 | >100 |
| Comp. | PE | | 5 | Reel | ◯ | Excellent | 8 | <2 |
| Ex. 1 | | | | | | | | |
| Comp. | PP | | 5 | Reel | ◯ | Excellent | 8 | <3 |
| Ex. 2 | | | | | | | | |
| Comp. | PP | | 15 | Reel | ◯ | Excellent | 8 | <10 |
| Ex. 3 | (CCS) | | | | | | | |
| Comp. | PP | | 15 | Reel | ◯ | Excellent | 8 | <15 |
| Ex. 4 | (MFS) | | | | | | | |
| Comp. | PU | | 100 | Magazine | X | Poor | 3 | >150 |
| Ex. 5 | foam | | | | | | | |
| Comp. | Acrylic | | 100 | Magazine | X | Poor | 2 | >200 |
| Ex. 6 | foam | | | | | | | |
| Comp. | PTFE | | 500 | Magazine | X | Poor | 1 | <50 |
| Ex. 7 | foam | | | | | | | |

Table 1 notes:
PE: polyethylene; PP: polypropylene; CCS: Ceramic Coated Separator; MFS: Multi-Functional Separator; PU: polyurethane; PTFE: polytetrafluoroethylene.

Referring to Table 1, Examples were evaluated according to a stack process, an energy density, a production speed, and a short circuit occurrence time according to a type of the buffer film 20 and a supply method. In detail, the evaluation metrics included a degree of a difficulty, an energy density, a production speed, and a shorting occurrence time when the buffer film 20 was applied to the stacking process.

For the production speed, the production speed was said to be 10 when the buffer film was not applied, and the speed when the buffer film was applied was thus evaluated in relation thereto.

The shorting occurrence time was evaluated as a time (hours) required for the shorting to occur during a cycle-life.

The Examples 1 to 5 were evaluated according to the mixing ratio of the first particulate MS1, which is a restoring force component of the buffer layer 22 formed on the PE base substrate 21, and the second particulate MS2, which is a stress relief component. Table 1 shows a weight ratio (MS1:MS2) of the first and second particulate MS1 and MS2 in the buffer layer 22.

Referring to Table 1, it can be seen that, as the content of second particulate MS2 increases, the shorting occurrence time tends to increase and then decrease again. As for the weight ratio MS1:MS2 of the first and second particulates MS1 and MS2, it may be seen that the shorting occurrence time is the latest at the ratio of 0.3:0.7.

The Examples 6 to 10 are for the buffer layer 22 formed on the PP base substrate 21, the weight ratio (MS1:MS2) of two buffer components of the first and second particulates MS1 and MS2 is 0.3:0.7, and the shorting occurrence time was confirmed while reducing the thickness from 100 μm to 10 μm. It was confirmed that the buffering capacity decreased as the thickness decreases.

The Comparative Examples 1 and 2 confirm the buffering performance of PE and PE fabrics. It was confirmed that the fabric itself of PE and PP had almost no buffering function.

The Comparative Examples 3 and 4 are separators including a coating layer applied to a lithium ion battery (LIB), and although there was a slight improvement compared to the fabric, it may be confirmed that the performance, as compared to the buffer layer 22 of the Example including the first and second particulates MS1 and MS2, was lower.

The Comparative Examples 5 to 7 are to apply a conventional buffering pad material. This buffering pad showed a very high buffering characteristic compared to the PE and PP base substrates. However, as compared to the buffer film 20 formed on the PE or PP base substrates that were used, it was confirmed that this buffering pad was very inferior in terms of the stacking process, the energy density, and the production speed.

In addition to the structures discussed above in connection with the drawings and the evaluated Examples, the buffer film may be formed in a two-layered structure of a high restoring force material and a high buffer and relaxation material (not shown in the drawings). A solid type of silicone rubber pad may be applied for high restoring force, and a sponge type of PTFE layer may be applied for high stress relief.

To provide a desirable level of energy density, the buffer film may be formed to a thickness of 300 μm or less, e.g., to be thin in the thickness range of the separator of the lithium ion battery (LIB). Considering characteristics of performance and energy density, the buffer film may be implemented with a final thickness of 50 μm or less, preferably 20-30 μm.

FIG. 5 is a cross-sectional view of a fully solid battery module according to a third example embodiment.

Referring to FIG. 5, a fully solid battery module 300 of the third embodiment includes a plurality of stacked cells 310 that are stacked while including at least one unit cell (e.g., UC1 or UC2), the upper plate 320 and the lower plate 330 provided on the top and bottom surfaces of the stacked cells 310, the buffering pad 50, and the fastening member 340.

The buffering pad 50 is formed as a sheet and is disposed between a plurality of stacked cells 310, between the uppermost surface and the upper plate 320, and between the lowermost surface and the lower plate 330. The sheet-type buffering pad 50 uniformly allows for the precipitation and dissociation of lithium generated from the negative electrode plate 13 during charging and discharging of each adjacent stacked cell 310 such that the stress applied to the solid electrolyte layer 12 disposed between the negative electrode plate 13 and the positive electrode plate 11 may be relieved. The buffering pad 50 may be composed with the same physical properties as the buffer film 20 used in the stacked cell 310, that is, the unit cell (UC1, UC2), while the buffering pad 50 used outside may be formed thicker than the buffer film 20 used inside.

In the structure shown in FIG. 5, the fastening member 340 passes through the upper plate 320 and is screwed onto the lower plate 330. Also, a spacer 350 is interposed between the upper and lower plates 320 and 330, and the spring 360 is interposed on the outside of the upper plate 320.

The stacked cells 310 may be formed as a pouch type of cell or a can type of cell, and may be electrically connected and stacked in a combination of in parallel and in series. The stacked cells 310 may be pressed by the upper and lower plates 320 and 330 and the spring 360 and the fastening member 340. As the fastening member 340 penetrates the upper plate 320 and screws into the lower plate 330, the stacked cells 310 between the upper and lower plates 320 and 330 are elastically pressed by the spring 360. The spacer 350 sets the minimum spacing of the upper and lower plates 320 and 330 to prevent over-compression of the stacked cells 310.

In the fully solid battery module 300, the spring 360 positioned on the upper plate 320 provides the pressing force and the restoring force for the stacked cells 310, and the buffering pad 50 provides for the relief of stress generated on and/or in the negative electrode plate 13.

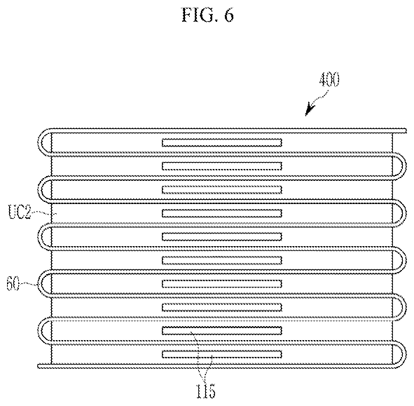

FIG. 6 is a cross-sectional view of a fully solid battery module according to a fourth example embodiment.

Referring to FIG. 6, in a fully solid battery module 400 of the fourth example embodiment, the unit cells UC2 are formed in the bi-cell, and a buffering pad 60 is formed in one sheet and is interposed between the unit cells UC2 in a continuous structure of the Z-stack type. That is, the buffering pad 60 is disposed in a zigzag state between the unit cells UC2 being stacked in the Z-stack type. The buffering pad 60 may be formed of the same materials as, and/or may have the same structure as, the buffer film 20.

In the fully solid battery module 400 made by stacking the bi-cells, the buffering pad 60 disposed between the unit cells UC2 may help provide for uniform precipitation and dissociation of lithium generated from the negative electrode plate 13 during charging and discharging of each unit cell UC2 adjacent thereto. Therefore, the stress applied to the solid electrolyte layer 12 disposed between the negative electrode plate 13 and the positive electrode plate 11 may be relieved. That is, during charging, lithium precipitation on the negative electrode plate 13 becomes uniform, and the precipitated lithium applies the uniform stress to the solid electrolyte layer 12. Thus, the above-described shorting may be prevented due to the result of the uniform precipitation and dissociation of the lithium precipitated layer 135.

In FIG. 6, positive electrode tabs 115 are connected to the uncoated region 113 of the positive electrode plate 11 of the unit cells UC2 drawn out to one side of the fully solid battery module 400. Although not shown, negative electrode tabs connected to the uncoated region of the negative electrode plate 13 of the unit cells UC are drawn out to the other side of the fully solid battery module 400.

As described above, embodiments relate to a fully solid battery including a positive electrode plate, a solid electrolyte layer, a negative electrode plate, and a buffer film, and a battery module including the same.

An example embodiment may provide a fully solid battery that enables uniform precipitation and dissociation of lithium from a negative electrode plate during charging and discharging. An example embodiment may provide a fully solid battery that prevents a capacitive charge and prevents damage of the solid electrolyte layer and an internal short circuit. An example embodiment may provide a fully solid battery module to which the above-described fully solid battery is applied.

A fully solid battery according to an example embodiment may employ the buffer film, having the buffer layer formed on the base substrate, applied to the back surface of one side of the negative electrode plate, and may include the first particulate MS1 included in the buffer layer providing resilience to the buffer layer and the buffer film, and the second particulate MS2 included in the buffer layer relieving the stress on the buffer layer and the buffer film. Accordingly, uniform precipitation and dissociation of lithium from the negative electrode plate during charging and discharging may be provided.

Additionally, a fully solid battery according to an embodiment may be structured to prevent oxidation of the precipitated lithium during the uniform precipitation and dissociation of lithium, thereby preventing a capacitive charge and preventing damage to the solid electrolyte layer and internal shorting. Because the physical defect of the solid electrolyte layer, which is the cause of the short circuit, is blocked, the cycle-life of the charge and discharge battery may be improved, and the battery capacity, that is, the usage time due to the internal short circuit, may be prevented from dropping.

Also, the manufacture of the fully solid battery according to one embodiment may have high utilization for equipment and processes that are used for manufacture of a lithium ion battery (LIB). Thus, when existing equipment for the lithium ion battery is used, cost may be reduced, and mass productivity may be increased.

In a fully solid battery module according to an example embodiment, a plurality of cells, e.g., unit cells, may be stacked and pressed, upper and lower plates may be disposed on the top and bottom surfaces of the stacked cells, and buffer pads may be disposed between the uppermost surface of the stacked cells and the upper plate, and between the lowermost surface of the stacked cells and the lower plate. The upper and lower plates may be fastened around the stacked cells using fastening members, e.g., to apply the pressure to the unit cells. This structure including the buffer pads may help to make uniform the stresses that occur at the negative electrode side within each unit cell.

In a fully solid battery module according to an example embodiment, a buffer pad may be interposed in a Z-stack type continuous structure, which may help to lower process costs and increase production speed. This may help make the fully solid battery module more advantageous and competitive relative to a lithium ion battery (LIB). Also, LIB manufacturing processes may be applied to the fully solid battery module, to thus enhance mass productivity.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

### DESCRIPTION OF SYMBOLS

11: positive electrode plate
12: solid electrolyte layer
13: negative electrode plate
20: buffer film
21: base substrate
22: buffer layer
30: finishing member
50, 60: buffer pad
111: positive current collector
112: positive active material layer
113, 133: uncoated region
114, 134: taping
131: negative current collector
132: positive active material layer
135: lithium precipitated layer
100, 200: fully solid battery
300, 400: fully solid battery module
310: stacked cell
320: upper plate
330: lower plate
340: fastening member
350: spacer
360: spring
MS1: first particulate
MS2: second particulate
UC, UC2: unit cell

What is claimed is:

1. A fully solid battery, comprising:
a positive electrode plate;
a solid electrolyte layer disposed on one side of the positive electrode plate;
a negative electrode plate disposed on one side of the solid electrolyte layer; and
a buffer film disposed on one side of the negative electrode plate, the buffer film including a base substrate and a buffer layer on at least one surface of the base substrate, the buffer layer including:
a first particulate that provides resilience;
a second particulate that relieves stress; and
a binder.

2. The fully solid battery as claimed in claim 1, wherein the buffer layer forms a closest packing structure in which the first particulate and the second particulate are in contact with each other.

3. The fully solid battery as claimed in claim 1, wherein:
the positive active plate has a positive active material thereon, and
the first particulate and the second particulate each have a particle diameter that is equal to or smaller than a particle diameter of the positive active material formed.

4. The fully solid battery as claimed in claim 1, wherein
the first particulate includes at least one of a polystyrene particulate or a silicone particulate, and
the second particulate includes at least one of an acryl particulate or a polytetrafluoroethylene particulate.

5. The fully solid battery as claimed in claim 1, wherein the positive electrode plate, the solid electrolyte layer, and the negative electrode plate form a unit cell that acts for charging and discharging on one side of the positive electrode plate as a mono-cell.

6. The fully solid battery as claimed in claim 1, wherein the positive electrode plate, the solid electrolyte layer, and the negative electrode plate form a unit cell that acts for charging and discharging on both sides of the positive electrode plate as a bi-cell.

7. A fully solid battery module, comprising:
a plurality of stacked cells formed by stacking at least one unit cell including a positive electrode plate, a solid electrolyte layer disposed on one side of the positive electrode plate, a negative electrode plate disposed on one side of the solid electrolyte layer, and a buffer film disposed on one side of the negative electrode plate;
upper and lower plates provided on the top and bottom surfaces of all stacked cells;
a buffer pad disposed between a plurality of stacked cells, between the uppermost surface and the upper plate, and between the lowermost and the lower plate; and
a fastening member fastening the upper plate and the lower plate.

8. The fully solid battery module as claimed in claim 7, wherein the stacked cells are formed as a pouch type or a can type.

9. A fully solid battery module, comprising:
a plurality of stacked cells formed by stacking at least one unit cell including a positive electrode plate, a solid electrolyte layer disposed on one side of the positive electrode plate, a negative electrode plate disposed on one side of the solid electrolyte layer, and a buffer film disposed on one side of the negative electrode plate; and
a buffer pad disposed between a plurality of unit cells,
wherein the buffer pad is formed in one sheet and is interposed in a continuous structure of a Z-stack type between the unit cells.

10. The fully solid battery module as claimed in claim 9, wherein the unit cell is formed as a bi-cell.
